(19) United States
(12) Patent Application Publication
(10) Pub. No.: US 2020/0095792 A1
(43) Pub. Date: Mar. 26, 2020

(54) Pool Cleaner

(71) Applicant: Pentair Water Pool and Spa, Inc., Cary, NC (US)

(72) Inventors: James Miller, Sanford, NC (US); William Evans, Apex, NC (US); Mitchell Bellamy, Sanford, NC (US); Stephen Mitchell, Chapel Hill, NC (US); Adam Key, Raleigh, NC (US); Montie Roland, Sanford, NC (US); David Vaughn, Pittsboro, NC (US)

(21) Appl. No.: 16/582,384

(22) Filed: Sep. 25, 2019

Related U.S. Application Data
(60) Provisional application No. 62/736,295, filed on Sep. 25, 2018.

(51) Int. Cl. E04H 4/16

(52) U.S. Cl. CPC E04H 4/1654; B08B 1/04

(57) ABSTRACT

Some embodiments of the invention provide a pool cleaner including a housing, a cavity defined within the housing, and a removable debris container received within the cavity. The pool cleaner includes a modular components that may be individually accessed and/or removed for servicing or replacement without disturbing other system components. The pool cleaner can include electronics modularly housed in an electronics housing. The pool cleaner can include a modular drive system for moving the pool cleaner, and a modular hydraulic system that draws water and debris into the housing, and discharges filtered water, providing thrust to the pool cleaner. Also, scrubbers individually coupled to the housing can include helical vanes configured to guide debris into a debris inlet of the pool cleaner.

### RELATED APPLICATIONS

This application claims priority under 35 U.S.C. § 119 to U.S. Provisional Patent Application No. 62/736,295 filed on Sep. 25, 2018, the entire contents of which is incorporated herein by reference.

### BACKGROUND

Most automatic pool cleaners include one or more components for driving the pool cleaner along a floor and sidewalls of a swimming pool. For example, conventional pressure-side cleaners and suction-side cleaners often use hydraulic turbine assemblies as drive systems to drive the wheels. Water supplied through the pool cleaner drives the turbine assemblies, which in turn, drive the wheels. Robotic pool cleaners have also been developed that utilize a motor instead of water as the driving force.

### SUMMARY

Some embodiments of the invention provide a pool cleaner including a housing and a debris container slidably coupled to the housing. The debris container is configured to be moved in a direction along a plane of travel of the pool cleaner for removal from the housing. In some embodiments the debris container defines a longitudinal axis parallel to a surface on which the pool cleaner is configured to be positioned. The debris container is configured to be moved in a direction other than perpendicular to the longitudinal axis to be removed from the housing.

Some embodiments of the invention provide a pool cleaner including a housing having opposing front and rear walls, opposing first and second side walls, a top wall, and a bottom wall. At least two wheels coupled to the first and second side walls and are configured to move the pool cleaner along a surface. The pool cleaner further includes at least one scrubber positioned between the at least two wheels. The at least one scrubber has a plurality of vanes arranged in a helical pattern.

Some embodiments of the invention provide a pool cleaner including a housing, a debris container positioned within the housing, and a hydraulic system. The hydraulic system is configured to pull water and debris into the housing and to push filtered water out of the housing after the debris is collected in the debris container. The filtered water exits the housing through a top wall of the housing.

Some embodiments of the invention provide a pool cleaner including a one-way valve formed in the bottom wall of the housing and a vertically-oriented outlet and a vertically-oriented one-way valve flap covering the vertically-oriented outlet in a closed condition.

Some embodiments of the invention provide a pool cleaner including a debris container received within the housing, and an inlet manifold extending between the bottom wall of the housing and the debris container. The inlet manifold has a cross-section that decreases from the bottom wall to the debris container.

Some embodiments of the invention provide a pool cleaner including wheels coupled to each of first and second side walls, respectively, and configured to move the pool cleaner along a surface. The pool cleaner further includes a drive system having a motor configured to drive at least one of the wheels. The motor is modularly retained within the housing so that the motor is individually accessible.

Some embodiments of the invention provide a pool cleaner with multiple compartments formed within the housing, including a first compartment housing hydraulic components, a second compartment housing electrical components, and a third compartment housing drive system components. Each one of the compartments is sealed from the other compartments so that components within each of the compartments are individually accessible.

Some embodiments of the invention provide a pool cleaner including a drive system, a hydraulic system, and a collector system. The drive system includes drive components to move the housing along a surface to be cleaned. One or more of the drive components are configured to be removed without disturbing the hydraulic system and the collector system. The hydraulic system includes hydraulic components that move fluid through the housing. At least one of the hydraulic components is configured to be removed without disturbing the drive system and the collector system. Additionally, the collector system includes collector components that collect debris from the surface to be cleaned. One or more of the collector components is configured to be removed without disturbing the hydraulic system and the drive system.

Some embodiments of the invention provide a pool cleaner including a housing, a lid, and a debris container. The lid is movable between an open and closed position. The debris container is housed within the cavity and configured to be ejected from the cavity when the lid is moved from the closed position to the open position.

Some embodiments of the invention provide a pool cleaner including a housing, a debris container positioned within the housing, and a hydraulic system configured to pull water and debris into the housing and push filtered water out of the housing after the debris is collected in the debris container. The hydraulic system includes a pump with a pump motor housed within a pump housing including three protrusions, a shaft extending from the pump motor, and a pump impeller coupled to an end of the shaft opposite the pump motor. The hydraulic system also includes an outlet system including an inlet manifold configured to receive the pump impeller and one or more outlet ducts configured to direct the filtered water from the inlet manifold out of the housing. The inlet manifold also includes three apertures each configured to receive one of the three protrusions to align the pump housing with the inlet manifold.

### DESCRIPTION OF THE DRAWINGS

FIG. 1 is a top, front, and side perspective view of a robotic pool cleaner according to one embodiment of the invention;

FIG. 2 is a top, rear, and side perspective view of the robotic pool cleaner of FIG. 1;

FIG. 3 is a cross-sectional view taken generally along the lines 3-3 of FIG. 2 and showing internal components and features of the robotic pool cleaner of FIGS. 1 and 2;

FIG. 4 is a block diagram of a control system for the pool cleaner disclosed in FIGS. 1-3 and 5-19;

FIG. 5 is an exploded rear, top, and side perspective view of the pool cleaner of FIGS. 1 and 2 with a debris container removed;

FIG. 6 is an exploded top and side perspective view of the debris container of FIG. 5 and a lid of the pool cleaner of FIGS. 1 and 2;

FIG. 7 is an enlarged view of a latching mechanism of the debris container of FIG. 5;

FIG. 8 is a bottom elevational view of the pool cleaner of FIGS. 1 and 2;

FIG. 9 is an enlarged perspective view of an inlet manifold of the pool cleaner of FIGS. 1 and 2;

FIG. 10 is a cross-sectional view taken generally along the lines 10-10 of FIG. 2 and showing outlet ducts for dispensing water from the pool cleaner of FIGS. 1 and 2;

FIG. 11 is an enlarged front view of the pool cleaner of FIGS. 1 and 2 with a front wall removed;

FIG. 12 is a partial, enlarged view of a front portion of the pool cleaner of FIGS. 1 and 2 with portions of two scrubbers exploded and brushes removed from the scrubbers;

FIG. 13 is a view of internal components of the pool cleaner of FIGS. 1 and 2;

FIG. 14 is a perspective view of some components of a drive system of the pool cleaner of FIGS. 1 and 2;

FIG. 15 is a side perspective view of the pool cleaner of FIGS. 1 and 2 with the wheels removed for viewing additional components of the drive system of FIG. 14;

FIG. 16 is an enlarged, perspective view of an inner portion of a rear wheel of the pool cleaner of FIGS. 1 and 2;

FIG. 17 is a bottom perspective view of the pool cleaner of FIGS. 1 and 2 depicting two one-way valves in a bottom wall of the pool cleaner; and

FIG. 18 is a top, perspective, and exploded view of one of the one-way valves of FIG. 17.

FIG. 19 is an exploded front, top, and side perspective view of the pool cleaner of FIGS. 1, 2, and 14 with a side wall omitted to depict a drive system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

Embodiments of the invention provide a cleaning vehicle for operation in enclosed aquatic environments. More specifically, embodiments of the invention provide an autonomous robotic pool cleaner for operation in aquatic environments, for example, swimming pool and/or spa environments. The autonomous robotic pool cleaner includes various features and components that optimize debris collection and operation of the pool cleaner in aquatic environments. The autonomous robotic pool cleaner may implement one or more control algorithms that further optimize debris collection and operation of the pool cleaner in aquatic environments.

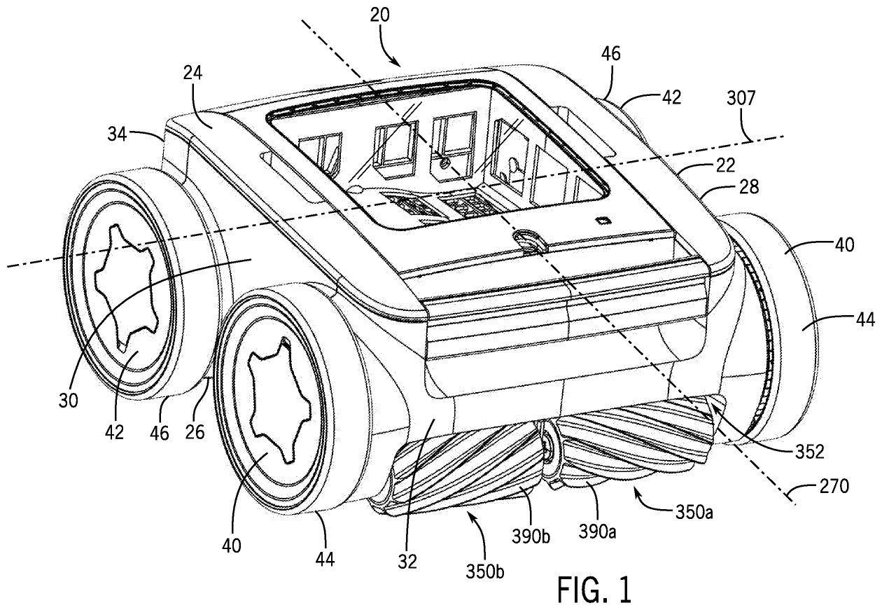

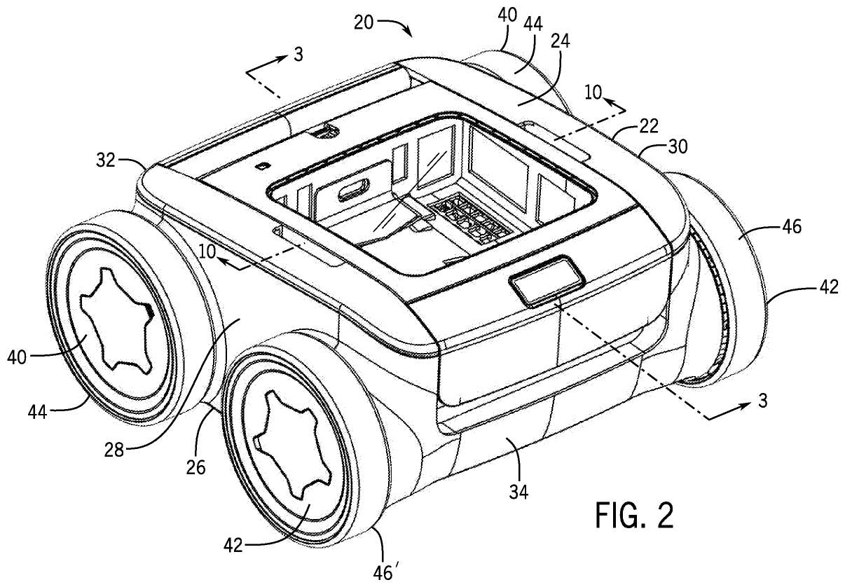

FIGS. 1 and 2 illustrate an autonomous robotic pool cleaner 20 according to some embodiments of the invention. The robotic pool cleaner 20 generally includes a housing 22 having a plurality of walls, for example, a top wall 24, a bottom wall 26, a first side wall 28, a second side wall 30 opposite the first side wall 28, a front wall 32, and a rear wall 34 opposite the front wall 32, that all form a generally rectangular shape. In other illustrative embodiments, the housing 22 may have any suitable number of walls and/or may have any suitable shape. While directional terminology is utilized herein (e.g., front, rear, forward, backward, etc.), such terminology is used to describe components or features in relation to one another and is not intended to be limited. For example, the walls 32, 34 are described as being front and rear walls, but one skilled in the art will understand that the robotic pool cleaner 20 is capable of moving in a first direction in which the front wall 32 is facing a direction of travel, but the pool cleaner 20 may also be reversed such that the rear wall 34 is facing a direction of travel.

Generally, the pool cleaner 20 can include at least two wheels coupled to the side walls for moving the pool cleaner 20 along a surface. In some embodiments, four wheels, including two front wheels 40 and two rear wheels 42, are operatively connected to the housing 22 for movement of the pool cleaner 20 along a surface to be cleaned. While four wheels are shown, any suitable number of wheels may be utilized. As seen in FIGS. 1 and 2, the rear wheels 42 may have a diameter that is substantially the same as a diameter of the front wheels 40. In other embodiments, a diameter of the front wheels 40 may be larger than a diameter of the rear wheels 42 or a diameter of the front wheels 40 may be smaller than a diameter of the rear wheels 42. The wheels 40, 42 may include tires 44, 46, respectively encircling the wheels 40, 42, wherein the tires 44, 46 may provide traction to the wheels 40, 42. Operation of the wheels 40, 42 for movement along a surface will be discussed in greater detail below.

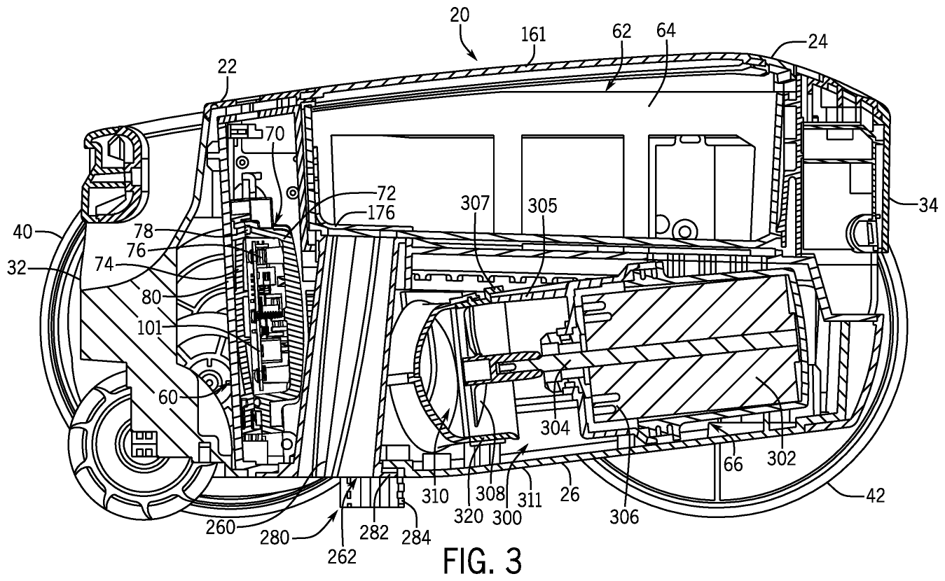

Referring to FIG. 3, the pool cleaner 20 generally includes a front compartment 60 holding a number of electrical components, an upper compartment 62 holding a debris container 64, and a lower compartment 66 holding a pump (as described in detail below) for moving water and debris through a hydraulic circuit within the pool cleaner 20. Each of the front compartment 60, the upper compartment 62, and the lower compartment 66 is modular in that the components may be separately accessed and/or removed (e.g., for servicing and/or replacing). In this manner, when components of the pool cleaner 20 need to be accessed, a user need not disassemble the entire pool cleaner 20 for access to certain components. Accordingly, in some embodiments, all replaceable components can be in individual, modular, waterproof enclosures to facilitate easy servicing or replacement.

As noted above, the front compartment 60 houses a number of electrical components of the pool cleaner 20, as seen in FIG. 3. An electronics housing 70 is positioned within the front compartment 60 and includes first and second shells 72, 74 forming a cavity 76 therebetween for the electrical components. A gasket 78 is positioned between outer edges of the first and second shells 72, 74 to create a water-tight seal between the first and second shells 72, 74, thus preventing water from entering the electronics housing 70. In order to access the electronics housing 70, the top wall 24 can be removed, granting access to the front compartment 60. In some embodiments, ultrasonic welding may be used to create a seal between the first and second shells 72, 74. The electronics housing 70 may be coupled to, for example, a forward wall 80 of the front compartment 60 by fasteners. Alternatively, the electronics housing 70 may be coupled to any portion of the front compartment 60 in any suitable manner. Because the electronics housing 70 is its own separate modular enclosure, it can be individually removed, replaced, and/or serviced while allowing components in other compartments, such as the pump and motor assemblies, to remain in place.

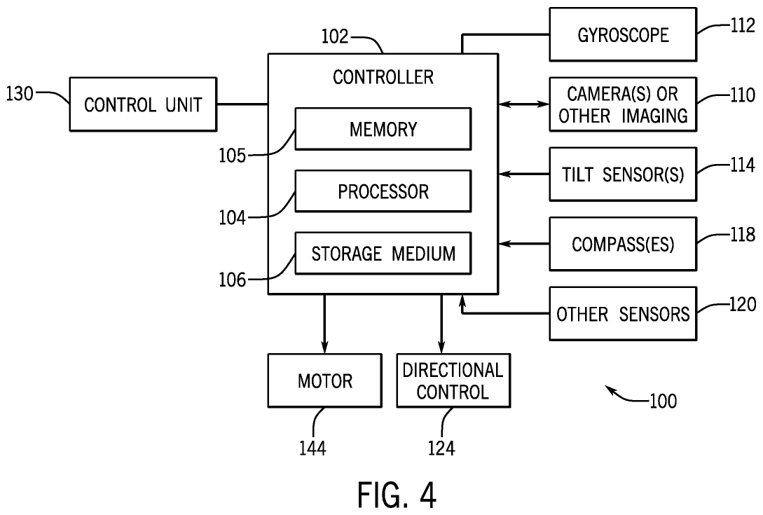

As shown in FIGS. 3 and 4, a control module or system 100 is implemented within a circuit board 101, for example a printed circuit board (PCB) or another suitable circuit board. The circuit board 101 is positioned within the electronics housing 70. The circuit board 101 includes a controller 102, such as a central processing unit (“CPU”), a graphics processing unit (“GPU”), or both. The circuit board 101 also includes a processor 104, memory 105, a storage medium 106, and/or any other suitable components (e.g., an input/output device, a display unit, a network interface device, a disk drive, etc.). The processor 104 may be, for example, a microprocessor, a microcontroller, digital signal processor, or another suitable processor. The processor 104 is communicatively coupled to the memory 105. The memory 105 may be embodied as a suitable computer memory device, including fixed and/or removable memory devices (e.g., volatile memory such as a form of random access memory or a combination of random access memory and read-only memory, such as memory cards, e.g., SD cards, memory sticks, hard drives, and/or others). Program code, for example, the control algorithms, may be stored within the memory 105 and/or on the storage medium 106. The program code can be executed by the processor 104 to perform various operations, as will be discussed in more detail below.

The control system 100 may further include suitable components for providing feedback to the controller 102 and/or to which the control system 100 provides instructions. Components that provide feedback or information to the control system 100 include, but are not limited to, one or more imaging devices 110 (for example, one or more of a camera or image sensor, a video camera, and/or any other suitable imaging device), which may be mounted on the housing 22 of the pool cleaner 20, for example, at a front edge, one or more gyroscopes 112, one or more tilt sensors 114, one or more accelerometers (not shown), one or more compasses 118, one or more other sensors 120, one or more inclinometers (not shown), or other components that can provide feedback, for example, about the pool cleaner 20 and/or the environment around the pool cleaner 20. Additionally, the controller 102 is capable of sending instructions to the imaging device 110, for example, to change an angle or viewing area of the imaging device 110 or to perform any other function. The controller 102 may also send instructions to one or more motors 144, as detailed below (such as motor 302, motor 400), to control operation of the pool cleaner 20, to a directional control 124 to control movement of the pool cleaner 20, and/or to any other components of the pool cleaner 20 to control any operation of the pool cleaner 20. The controller 102 may also receive data from any of the components of the pool cleaner 20, for example, regarding function of those components (e.g., fault or other conditions).

The control system 100 may be further connected to a network (not shown), so that the control system 100 can communicate with one or more remote control units 130, for example a computer, a mobile device, control modules or systems of other pool cleaners, or any other suitable devices. In this manner, instructions may be provided to the control system 100 to control various aspects of the pool cleaner 20. In one embodiment, a remote control unit 130 (e.g., by means of an application on a mobile device 130) may be utilized to turn the pool cleaner 20 on and off, control movement of the pool cleaner 20, and/or control any other components, functions, or features of the pool cleaner 20.

The control system 100 implements one or more algorithms that are intended to optimize cleaning paths, trajectories, or routes within an aquatic environment, for example a pool. In some embodiments, the algorithm can identify specific locations of debris within the aquatic environment and determine a best path to take based on size and location of debris along each potential path and a smoothness of each potential path. The control system 100 continuously evaluates different paths and takes the best path at each evaluation until the entire aquatic environment is clean. In this manner, the time necessary to clean the aquatic environment is much less than conventional pool cleaners. Such an algorithm is disclosed in more detail in U.S. Utility application Ser. No. 16/109,544, filed Aug. 22, 2018, the disclosure of which is hereby incorporated by reference in its entirety.

In other embodiments (or in alternative programs for the same pool cleaner), the algorithm may be random, may be programmed to make turns at pre-determined intervals, may have one or more pre-programmed algorithms, or may include any other suitable features. In one embodiment, the algorithm moves forward for a random period of time and then makes a turn (i.e., right or left), moves forward for a random period of time, and makes a turn (i.e., right or left), moves forward for a random period of time, and repeats turning and moving forward for a random period of time. In some embodiments, the pool cleaner 20 may include a control unit that is integrated into the pool cleaner 20 and accessible by a user and/or that is embodied in a remote control unit 130, as described above. Regardless, the control unit 130 may communicate with the controller 102 upon communication of one or more selections at the control unit 130 (e.g., by a user). Selections may include selection of an algorithm or cleaning program, selection of a speed, selection of a cleaning mode (e.g., a surface mode, a bottom mode, a sidewall mode, etc.), turning the pool cleaner 20 on/off, turning on one or more components of the pool cleaner 20 (e.g., camera, scrubbers, etc.), or other suitable features or functions that may be controlled.

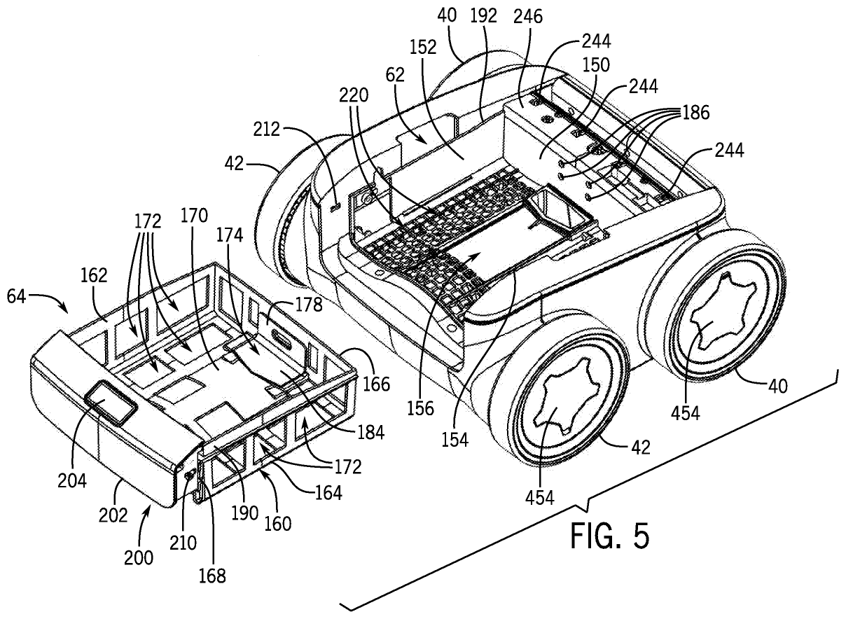

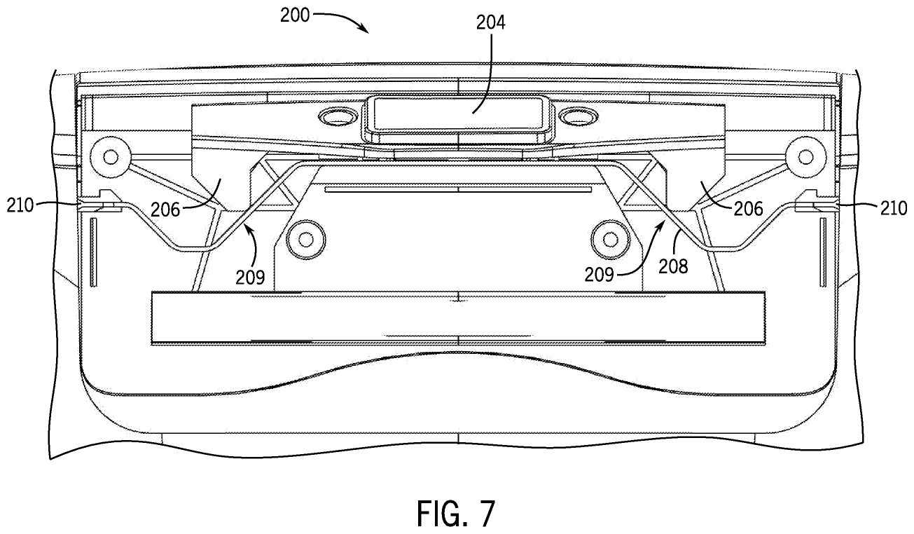

The upper compartment 62 houses a debris container 64, as seen in FIGS. 3 and 5-7, and generally includes a front wall 150 between the upper and front compartments 62, 60, first and second side walls 152, 154, a bottom wall 156 and a lid 161. The debris container 64 generally includes a housing 160, which may be rigid and generally includes first and second opposing side walls 162, 164, a front wall 166, a rear wall 168, and a bottom wall 170. Each of the walls 162, 164, 166, 168, and/or 170 can include apertures 172 for the flow of water. A screen or other mesh material may cover the apertures 172 to prevent the flow of debris out of the debris container 64. The screen or other mesh material may be replaced (with, for example, screens or other mesh materials having differently sized mesh or apertures) by a user for different applications, to target different types of debris, or if the mesh has become damaged or needs replacing. Additionally, as shown in FIG. 5, the bottom wall 156 of the upper compartment 62 includes a plurality of apertures 220 for the flow of water. Similar to the apertures 172, a screen or other mesh material may cover the apertures 220 (or only one set of the apertures 172 or 220) to prevent the flow of debris out of the debris container 64. The screen or other mesh material may be replaced (with, for example, screens or other mesh materials having differently sized mesh or apertures) by a user for different applications, to target different types of debris, or if the mesh has become damaged or needs replacing.

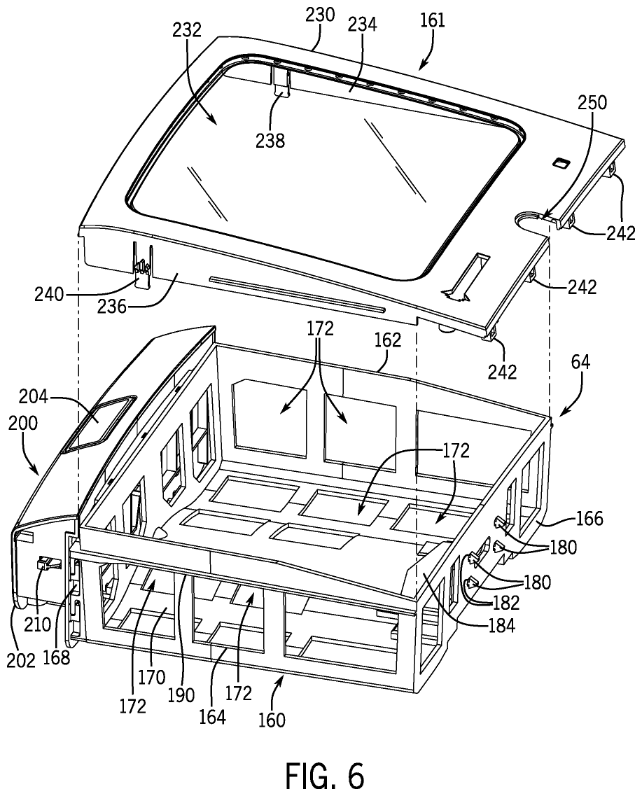

As shown in FIG. 5, a flap 174, or another suitable one-way valve, is attached to the front wall 166 and covers a debris container inlet 176, through which water and debris enter the debris container 64. The flap 174 includes a first segment 178 with prongs 180 that extend through apertures 182 in the front wall 166 of the debris container 64 (as shown in FIG. 6) and a second segment 184 that is hingedly connected to, and extends at a substantially right angle with respect to, the first segment 178 and covers the debris container inlet 176. The flap 174 allows water and debris to enter the debris container 64, but prevents water and debris from moving out of the debris container 64, acting as a one-way valve. As further seen in FIGS. 5 and 6, the prongs 180 extend through the front wall 166 and into apertures 186 in the front wall 150 between the front and upper compartments 60, 62 when the debris container 64 is slid into the upper compartment 62. The prongs 180 assist with proper alignment of the debris container 64.

Generally, the debris container 64 can be configured to be moved in a direction parallel to a direction of travel of the pool cleaner 20 for removal from the housing 22. In other words, the debris container 64 can be configured to be moved in a direction along a plane of travel of the pool cleaner 20. For example, in some embodiments, the debris container 64 is slid into and out of the upper compartment 62 with the first and second opposing side walls 162, 164 of the debris container 64 riding along the first and second side walls 152, 154 of the upper compartment 62. More particularly, in one embodiment, the first and second opposing side walls 162, 164 of the debris container 64 may include ridges 190 that rest upon and ride along ledges 192 formed within the side walls 152, 154 of the upper compartment 62. The ridges 190 and ledges 192 guide the debris container 64 into place within the upper compartment 62, permitting movement of the debris container 64 in a rearward direction for removal from the housing 22. Furthermore, upward movement of the debris container 64 is restricted by the lid 161. The lid 161 can also enclose the debris container 64 to trap debris within the debris container 64 when the debris container 64 is housed in the housing 22.

Accordingly, the debris container 64 can be configured to be moved in a substantially horizontal direction. For example, the debris container 64 can define a longitudinal axis (such as longitudinal axis 270) or plane that is parallel to a surface on which the pool cleaner 20 is configured to be positioned (such as a pool floor or wall). The debris container 64 can be moveable in a direction parallel to the longitudinal axis or plane, or any direction other than perpendicular to the longitudinal axis or plane, for removing the debris container 64 from the housing 22. This may be in contrast to other pool cleaners in which debris containers are vertically pulled out from the pool cleaner housing.

Referring now to FIGS. 5-7, the debris container 64 includes a handle 200 that may be grasped (e.g., at a lower edge 202) by a user to slide the debris container 64 into and out of the upper compartment 62 in a manner similar to that of a drawer. In order to remove the debris container 64 from the upper compartment 62, a user must first a push button 204 on the handle 200. Activation of the button 204 causes downwardly movement of lever arms 206, which deforms a latch connector 208 extending between opposing latches 210 at points 209. Deformation of the latch connector 208 pulls the latches 210 inwardly, retracting the latches 210 from their latched position within apertures 212 formed in the side walls 152, 154 of the upper compartment 62, and allowing the debris container 64 to be slid out of the upper compartment 62. Accordingly, the handle 200 and the button 204 can allow single-handed removal of the debris container 64 by a user. For example, the user can push the button 204 with their thumb and pull the debris container 64 outward from the housing 22 without having to touch any debris within the debris container 64. While a particular latch system is depicted, other suitable latching systems may additionally or alternatively be utilized.

In some embodiments, the debris container 64 can be configured to be self-ejecting from the upper compartment 62. In this embodiment, a spring, or another biasing mechanism, can be configured to push the debris container 64 out of the upper compartment 62 when the button 204 is activated.

As shown in FIGS. 1, 2, and 6, the upper compartment 62 includes a lid 161 having a top surface 230 with at least a portion including a transparent window 232 for viewing debris within the debris container 64. More specifically, the transparent window 232 is positioned above a least of portion of the debris container housing 160 for viewing debris within the debris container 64. A user can determine whether the debris container 64 needs to be emptied without removal of the debris container 64 or without otherwise manipulating the pool cleaner 20. In some circumstances, a user can see into the debris container 64 when the pool cleaner 20 is fully submerged within the aquatic environment. In a situation where the pool cleaner 20 has stopped working or a fault or error has been detected, a user can easily determine if the error is due to a full debris container 64. The lid 161 further includes first and second opposing side surfaces 234, 236 extending downwardly from opposing side edges of the top surface 230. The bottom edges of surfaces 234, 236 constrain the first and second opposing side walls 162, 164, preventing upward motion of the debris container 64. Each of the side surfaces 234, 236 includes a clip 238, 240 for attachment to the first and second side walls 152, 154 of the upper compartment 62. The clips 238, 240 can be released to allow quick removal of the lid 161 without tools (e.g., via a snap-fit connection). The top surface 230 may further include a plurality of alignment members 242 extending from a bottom surface. The alignment members 242 may be configured to extend into apertures 244 in a wall 246 forming a recessed portion of the upper compartment 62. The alignment members 242 and apertures 244 may provide positioning and alignment of the lid 161. In some embodiments, the alignment members 242 and apertures 244 may provide a pivot about which the lid 161 can rotate so that the lid 161 is hingedly coupled to the upper compartment 62. Rotation of the lid 161 enables a user to access the upper compartment 62 without completely removing the lid 161. The lid 161 further includes a notch 250 formed in the front end so that the notch 250 provides tether strain relief.

The lid 161 can be moveable between an open and a closed position. In the open position, the lid 161 can be removed from the upper compartment 62 (e.g., at least the clips 238, 240 can be removed from the side walls 152, 154), and in the closed position, the lid 161 may be coupled to the upper compartment 62 (e.g., the clips 238, 240 are engaged with the side walls 152, 154). In embodiments where the lid 161 is hingedly coupled to the upper compartment 62, the lid 161 may be rotatable between an open and a closed position. The debris container 64 can be configured to be received in or removed from the upper compartment 62 when the lid 161 is in the open position or the closed position. In some embodiments, the lid 161 need not be removed during normal operation, or for removal of the debris container 64, unless service or repair is necessary (e.g., to clean trapped debris, or to access other internal components of the pool cleaner 20). Also, in some embodiments, the debris container 64 can further be configured to be self-ejecting from the upper compartment 62 when the lid 161 is moved from the closed to the open position. For example, a spring, or another biasing mechanism, can be configured to push the debris container 64 out of the upper compartment 62 when the lid 161 is rotated toward the open position. In some embodiments, the debris container 64 can self-eject directly horizontally or at an upward angle when the lid 161 is rotated toward the open position.

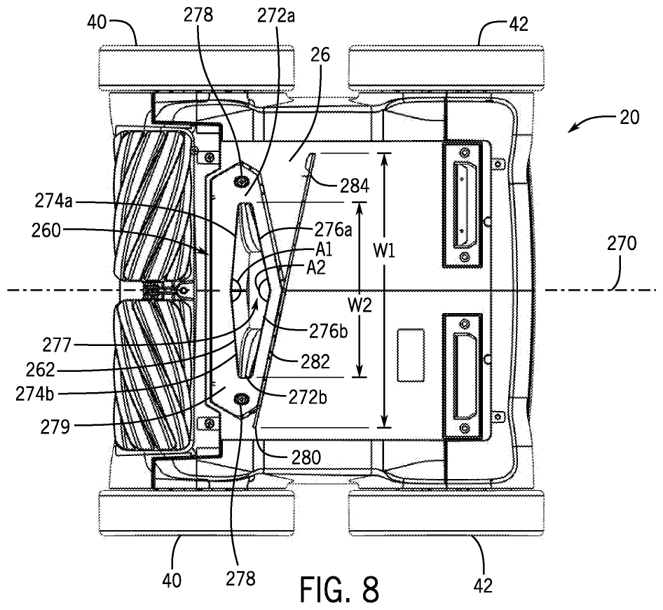

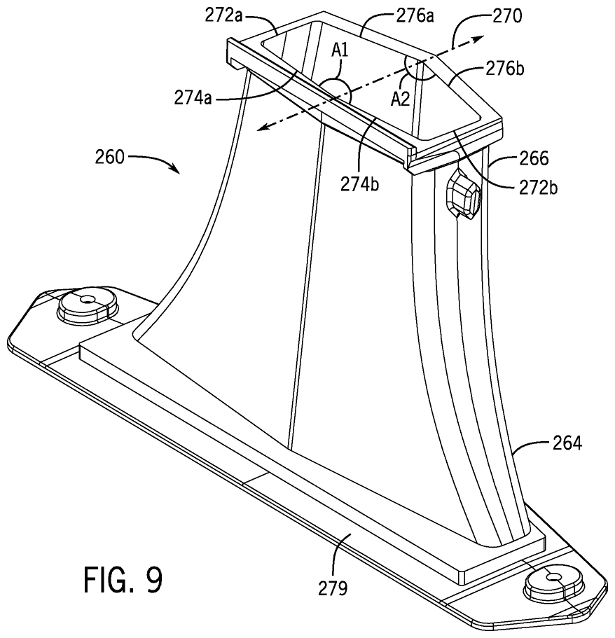

Referring now to FIGS. 8 and 9, an inlet manifold 260 extends between the bottom wall 26 of the pool cleaner 20 and the inlet 176 of the debris container 64. More particularly, an inlet 262 of the inlet manifold 260 (e.g., considered a debris inlet of the pool cleaner 20) is in fluid communication with water in the aquatic environment to allow water to travel through the inlet 262, through the inlet manifold 260, through the inlet 176, and into the debris container 64. Accordingly, the inlet manifold 260 can also interface with the inlet 176 of the debris container 64 to ensure debris travels into the debris container 64 (e.g., to help prevent debris from leaking outside of the debris container 64 and into other parts of the pool cleaner 20). The inlet manifold 260 has a first end 264 adjacent the inlet 262 that has a first cross-sectional area and a second end 266 adjacent the inlet 176 into the debris container 64 that has a second cross-sectional area, where the second cross-sectional area can be less than the first cross-sectional area. The decrease in cross-sectional area from the bottom wall 26 to the debris container 64 may speed up the flow of water through the inlet manifold 260 and into the debris container 64. Additionally, the decrease in cross-sectional area of the inlet manifold 260 can be gradual between the first and second ends 264, 266 so as to provide a smooth flow of water through the inlet manifold 260.

The cross-sectional area of the inlet manifold 260 at any point along the inlet manifold 260 is symmetrical about a longitudinal axis 270 of the pool cleaner 20. Further, the shape of each cross-section of the inlet manifold 260 is similar along a height of the inlet manifold 260 (except that the shape gets smaller). More particularly, the inlet manifold 260 includes first and second outer walls 272a, 272b that generally extend parallel to the longitudinal axis 270 of the pool cleaner 20 and have rounded corners. The inlet manifold 260 further includes first and second forward walls 274a, 274b extending from forward ends of the first and second outer walls 272a, 272b, respectively, and first and second rear walls 276a, 276b extending from rear ends of the first and second outer walls 272a, 272b, respectively. An angle A1 formed between the first and second forward walls 274a, 274b is greater than an angle A2 formed between the first and second rear walls 276a, 276b. The cross-sectional shape of the inlet manifold 260 (at any point along the inlet manifold 260) is generally hexagonal with differently sized walls and angles of differing sizes. Alternatively, the cross-sectional shape of the inlet manifold 260 may be considered generally diamond-shaped. The hexagonal shape (or diamond shape) of the inlet manifold 260 and the orientation of the walls 272a, 272b, 274a, 274b, 276a, 276b with respect to one another provide the inlet 262 with a central section 277 that is enlarged, allowing debris with a larger diameter to be collected through the inlet 262 and the inlet manifold 260. In other words, a length of the inlet manifold 260 increases from outside edges of the inlet manifold 260 to the center of the inlet manifold 260. Furthermore, larger diameter debris is funneled toward the central section 277 (e.g., by the scrubbers 350a, 350b) for collection, while not sacrificing suction flow velocity. More particularly, if the inlet 262 were to have a length such as at the central section 277 across an entire width, a desired suction flow velocity may not be met.

As can be further seen in FIGS. 3 and 8, the pool cleaner 20 may include a skirt 280 extending from the bottom wall 26 of the pool cleaner 20. The skirt 280 may be straight, have a first section 282 that extends adjacent the inlet manifold 260 parallel to the second rear wall 276b, and have a second section 284 that extends from the first section 282. The second section 284 is spaced rearwardly and at an angle with respect to the first rear wall 276a. In some embodiments, the skirt 280 may instead be bent or curved (not shown) to match the contour of the rearward portion of the inlet 262. For example, the first section 282 can extend adjacent the inlet manifold 260 parallel to the second rear wall 276b, and the second section 284 can extend parallel to the first rear wall 276a.

In some embodiments, the skirt 280 has a width W1 that is greater than or equal to a width W2 of the inlet manifold 260. In one embodiment, the width W1 may be 20% or more greater than the width W2. The skirt 280 assists in collecting debris that has passed the inlet 262 of the inlet manifold 260. As debris is collected by the skirt 280, the debris may get sucked into the inlet 262, increasing the collection capabilities of the pool cleaner 20. In some embodiments, the skirt 280 can also maintain a water flow velocity above a critical velocity that is required to entrain sand and other small particles into the inlet 262.

The skirt 280 is modular so that it can be easily removed and replaced or serviced by a user. In some embodiments, at least one fastener (not shown) is used to removably couple the skirt 280 to the bottom wall 26. A user can remove the fasteners to decouple the skirt 280 from the bottom wall 26. While at least one fastener, such as a screw or bolt, is used to couple the skirt 280 to the bottom wall 26 in some embodiments, other embodiments may use alternative fasteners, such as a snap fit configuration, to removably couple the skirt 280 to the bottom wall 26. Alternatively, in some embodiments, the skirt 280 may be held in place by the inlet manifold 260 and can be removed by removing the inlet manifold 260. While the skirt 280 in some embodiments is removably attached to the bottom wall 26, in other embodiments, the skirt 280 may be permanently coupled to the bottom wall 26 so that it is not easily detached. Additionally, in some embodiments, the skirt 280 is made of rubber or another similar material. In other embodiments, the skirt 280 may be made of a rigid material or another suitable material.

The inlet manifold 260 is removable from the housing 22 of the pool cleaner 20 through removal of one or more fasteners 278 extending through a lip 279 of the inlet manifold 260 and the bottom wall 26 of the housing 22. As a result, the inlet manifold 260 can be removed for servicing or replacement without requiring disassembly of other components of the pool cleaner 20. As noted above, removal of the inlet manifold 260 may also allow for removal of the skirt 280, for example, as the skirt may be L-shaped and may have a first horizontal segment (not shown) that is captured between a portion of the inlet manifold 260 and the bottom wall 26 and a second vertical segment (e.g., comprising sections 282, 284) that extends downwardly from the bottom wall 26 of the pool cleaner 20.

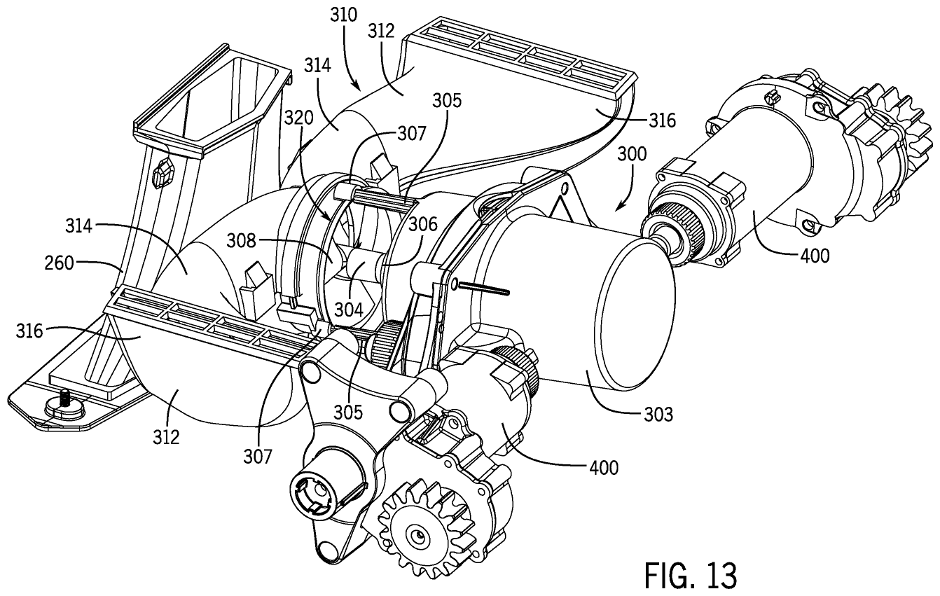

As shown in FIGS. 3, 10 and 13, the lower compartment 66 generally includes a hydraulic system 300 configured to pull water and debris into the housing 22 and push filtered water out of the housing 22 after the debris is collected in the debris container 64. The hydraulic system 300 can include one or more modular hydraulic components, for example, a pump comprising a pump motor 302, within a pump housing 303 (FIG. 13), and a shaft 304 extending from a first end 306 of the pump motor 302. A pump impeller 308 is attached to an end of the shaft 304 opposite the pump motor 302. The pump motor 302 rotates the shaft 304, which rotates the pump impeller 308. Rotation of the pump impeller 308 pulls water through the inlet 262, through the inlet manifold 260, through the debris container 64, and out an outlet system 310. Water and debris are pulled into the debris container 64, but due to the mesh material of the screens, only water is pulled out of the debris container 64, through the hydraulic system 300, and out one or more outlet ducts 312 of the outlet system 310. In this manner, filtered water is pushed out of the housing 22 after debris is collected from unfiltered water in the debris container 64.

The hydraulic system 300 is positioned within a separate compartment, the lower compartment 66. The modularity of the separate compartment allows for individual servicing without affecting other parts of the pool cleaner 20. For example, the lower compartment 66 may be easily accessed by, for example, removing a portion 311 of the bottom wall 156 of the housing 22 rearward of the inlet manifold 260 to service the hydraulic system 300. In this manner, there is no need to disassemble the entire pool cleaner 20 or portions of the pool cleaner 20 that are not in need of servicing. Furthermore, the pump (e.g., the pump motor 302, shaft 304, and pump impeller 308) may be modular in that the pump or one or more of its components may be selectively attached and detached from the outlet system 310 for ease in servicing the hydraulic system 300.

Referring again to FIGS. 3, 10, and 13, water pulled into the hydraulic system 300 by the pump impeller 308 is pushed out the outlet system 310 through two symmetrical outlet ducts 312. The water is directed along a first segment 314 of each outlet duct 312 that is generally perpendicular to the longitudinal axis 270 and extends outwardly, along a second segment 316 of each outlet duct 312 that generally extends upwardly, and out two symmetrically placed outlet ports 318 in the top wall 24 of the pool cleaner 20 (e.g., on opposing sides of the top wall 24). Generally, the first segment 314 (e.g., the horizontal component of the flow path through the outlet duct 312) can be shorter than the second segment 316 (e.g., the vertical component of the flow path through the outlet duct 312). Also, in some embodiments, a cross-sectional area of each outlet duct 312 can diverge (e.g., increase) along the flow path in order to reduce flow restrictions.

Given the geometry and placement of the outlet ducts 312, the discharge flow of water from the pool cleaner 20 has a vertical component. In some embodiments, the discharge flow of water may also have a small horizontal component (e.g., smaller than the vertical component). In other words, the discharge flow of water is angled slightly rearwardly. In this manner, the vertical component of the discharge flow may help retain the pool cleaner 20 on the surface to be cleaned and the horizontal component of the discharge flow provides a thrust force to help move the pool cleaner 20 along the surface to be cleaned and/or increases a velocity of the pool cleaner 20 along the surface to be cleaned. The horizontal component of the discharge can also assist the pool cleaner 20 in climbing inclined surfaces or walls. Also, while the cross-sectional area of the each outlet duct 312 generally diverges along the flow path, each outlet duct 312 can include a slight decrease in cross-sectional area at the end of the flow path (i.e., at the outlet ports 318), which can help increase a velocity of the water exiting the pool cleaner 20.

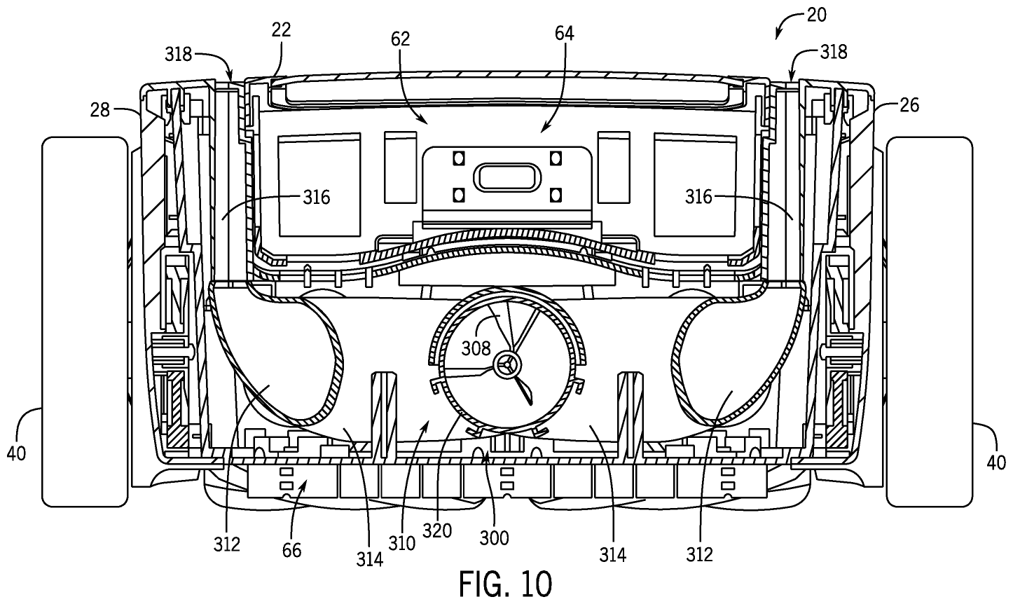

As shown in FIGS. 3 and 10, the pump impeller 308 is positioned within an inlet manifold 320 of the outlet system 310. The walls forming the inlet manifold 320 have a diameter that is slightly larger than a diameter of vanes forming the pump impeller 308. In this manner, a gap between an outer dimension of the impeller vanes and an inner surface of the inlet manifold 320 is minimized, increasing overall efficiency of the hydraulic system 300, including the pump motor 302, while still allowing recirculation of flow around the outer portion of the impeller vanes.

Also, as shown in FIGS. 3 and 13, the pump housing 303 can be coupled to the inlet manifold 320 via a three-point mounting system. More specifically, a front portion of the pump housing 303 can include three protrusions 305 (though only two protrusions 305 are shown in FIG. 13) and the inlet manifold 320 can include three mating apertures or blind holes 307 configured to receive the protrusions 305. In this manner, the pump housing 303 can be precisely aligned with the inlet manifold 320 by fitting the protrusions 305 into the apertures 307. This improved alignment allows for less clearance in the gap between the vanes of the pump impeller 308 and the inner surface of the inlet manifold 320 (as discussed above), increasing efficiency of the hydraulic system 300. Furthermore, the mounting system permits quick disassembly of the pump from the inlet manifold 320, for example, permitting easy access to the impeller 308 for servicing, as well as quick and precise realignment of the components when servicing is complete. Alternatively, the mounting system, by providing the three protrusions 305 with open space between, can permit access to the impeller 308 (e.g., for servicing) without requiring removal of the pump housing 303 from the inlet manifold 320.

Additionally, the hydraulic system 300, including the pump motor 302, shaft 304, and impeller 308, is positioned in a center of the pool cleaner 20 (along a lateral axis 307 of the pool cleaner 20, shown in FIG. 1, perpendicular to the longitudinal axis 270) and directly behind the inlet 262. The central position of the hydraulic system 300 can help in providing balanced discharge from the outlet ducts 312 and the outlet ports 318, providing balanced vertical and horizontal thrust.

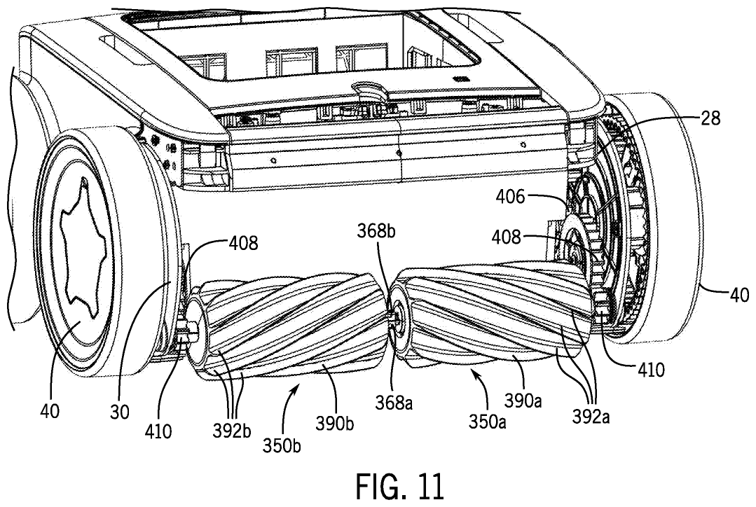

As shown in FIGS. 1, 11, and 12, two scrubbers 350a, 350b are positioned within the front wall 32 of the pool cleaner 20, generally between the front wheels 40. More particularly, a cavity 352 is formed in the front wall 32 and the scrubbers 350a, 350b are positioned at least partially within the cavity 352. Each of the scrubbers 350a, 350b generally includes a cylindrical core 354a, 354b with a plurality of cavities 356a, 356b. In some embodiments, each of the plurality of cavities 356a, 356b provide a mechanical lock for retaining over-molded rubber on the cylindrical cores 354a, 354b. Projections 358a, 358b extend outwardly from outer ends 360a, 360b of each of the scrubbers 350a, 350b for coupling to a drive system. Additionally, connecting members 362a, 362b are positioned within cylindrical cavities 364a, 364b within inner ends 366a, 366b of the cylindrical cores 354a, 354b. Each of the connecting members 362a, 362b includes a joint 368a, 368b that overlaps the joint 368a, 368b of the other connecting member 362a, 362b. A fastener 370 couples the joints 368a, 368b to an intermediate support member 372 extending from an inner surface of the cavity 352 to retain the scrubbers 350a, 350b within the cavity 352. The cylindrical cores 354a, 354b have longitudinal axes 374a, 374b that are coextensive with one another. While two scrubbers are depicted, another suitable number of coextensive scrubbers (including one) may be utilized. Still further, while the scrubbers 350a, 350b are shown at a front of the pool cleaner 20, scrubbers may alternatively or additionally be positioned centrally along the pool cleaner 20 and/or at a rear of the pool cleaner 20. The scrubbers 350a, 350b further include cylindrical brushes 390a, 390b positioned around each of the cylindrical cores 354a, 354b. The cavities 356a, 356b can assist in retaining the cylindrical brushes 390a, 390b on the cylindrical cores 354a, 354b. Each of the cylindrical brushes 390a, 390b includes a plurality of vanes 392a, 392b extending outwardly. Each of the pluralities of vanes 392a, 392b is formed in a helical pattern. More particularly, as seen in FIG. 11, the vanes 392a of the brush 390a rotate around the brush 390a in a counter-clockwise direction between the first side wall 28 and the intermediate support member 372 and the vanes 392b of the brush 390a rotate or spiral in a clockwise direction between the intermediate support member 372 and the second side wall 30. As the pool cleaner 20 travels along a surface and encounters debris, the helical vanes 392a, 392b and the rotation of the helical vanes 392a, 392b serve to agitate debris stuck on the surface to be cleaned, so that the debris can be pulled into the inlet 262, through the inlet manifold 260, and into the debris container 64. The helical vanes 392a, 392b also pull debris from outer ends of the scrubbers 350a, 350b (i.e., adjacent the wheels 40) toward a center of the pool cleaner 20, funneling debris to a point between the scrubbers 350a, 350b, which is the point of highest suction through the inlet 262. Funneling debris to the center of the pool cleaner 20 increases the chances of the debris being picked up through the inlet 262 of the pool cleaner 20, thus increasing the cleaning efficiency of the pool cleaner 20. The helical vanes 392a, 392b can also break up a pile of debris and spread it out across the vanes 392a, 392b using helical motion so that the pool cleaner 20 has a better chance of picking up all of the debris in one pass. In one example, the length and curvature of the helical vanes 392a, 392b (including the distance between the helical vanes 392a, 392b) can be dimensioned to collect sand particles, funneling the particles into the inlet 262. Alternatively, the helical vanes 392a, 392b can be dimensioned to more effectively collect other types of debris. Also, in some embodiments, the brushes 390a, 390b can be injection molded.

Each of the scrubbers 350a, 350b are modular and can be individually replaced or serviced as needed. For example, the fastener 370 can removed from the intermediate support member 372 to allow a user to remove one of the scrubbers 350a, 350b. While it may be desirable to replace at least one entire scrubber 350a, 350b, a user can alternatively replace only some scrubber components. In one example, it may be desirable to replace at least one cylindrical core 354a, 354b and/or cylindrical brush 390a, 390b.

As described above, the pool cleaner 20 includes a plurality of wheels, for example, a set of front wheels 40 and a set of rear wheels 42. One front wheel 40 and one rear wheel 42 are operatively coupled to the first side wall 28 and one front wheel 40 and one rear wheel 42 are operatively coupled to the second side wall 30. Each of the wheels 40, 42 is driven by a drive system that may include at least one modular drive component, for example, a plurality of axles, gears, and/or other components that are operatively connected to, for example, a motor that provides rotational energy to the axles, gears, and/or other components. In other embodiments, the pool cleaner 20 may be pressure- or suction-driven, in which case the pool cleaner 20 may include a turbine or other fluid directing device that controls a flow of water through the pool cleaner 20 to rotate the wheels 40, 42.

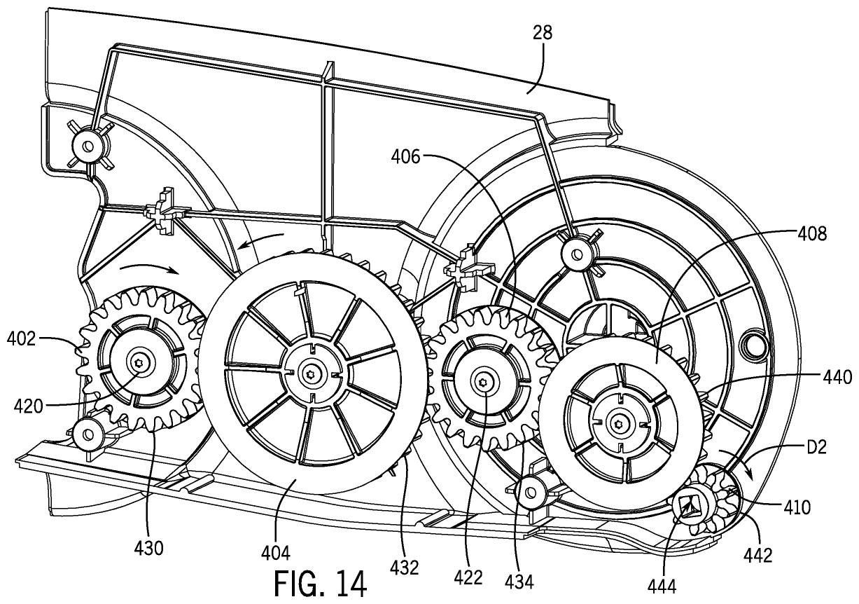

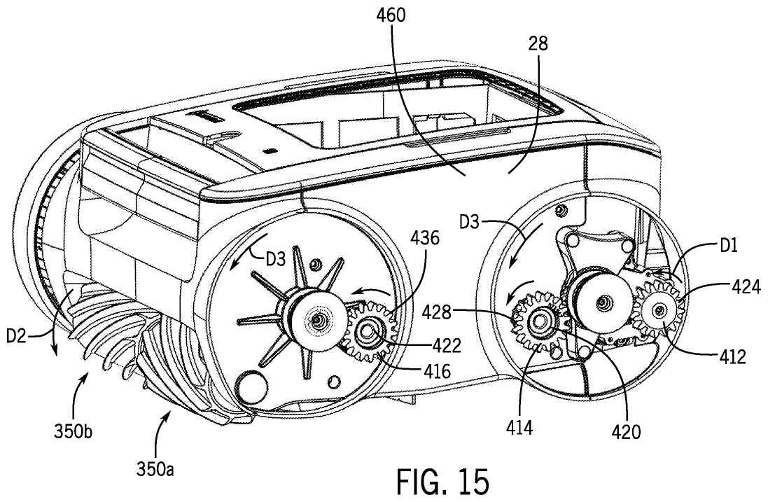

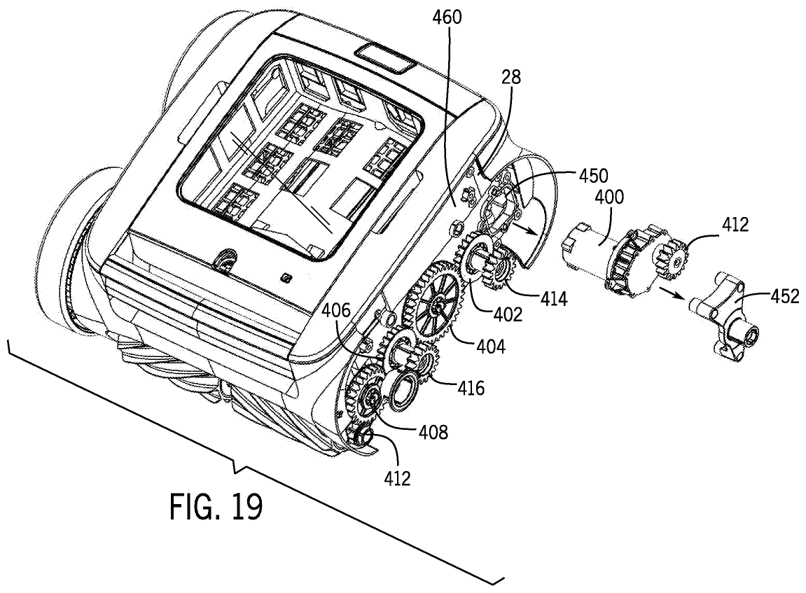

In some embodiments, the wheels 40, 42 are driven by a drive system that includes two motors 400, as shown in FIG. 13, and a plurality of gears, as shown in FIGS. 14 and 15. The drive system is further illustrated in FIG. 19 with side wall 28 omitted to depict additional detail. The motors 400 are controlled by the controller 102 according to one or more control algorithms. Each set of wheels 40, 42 (e.g., right side and left side) is controlled by one of the motors 400, and each set of wheels 40, 42 (e.g., right side and left side) includes a plurality of gears positioned on inner and outer sides of the respective side wall 28, 30. The motor 400 and gears on the right side of the pool cleaner 20, i.e., adjacent the first side wall 28, will now be discussed in detail, it being understood that the motor 400 and the gears on the left side of the pool cleaner 20, i.e., adjacent the second side wall 30, are mirror images of those on the right side of the pool cleaner 20. Furthermore, while two motors 400 are shown and described herein, in some embodiments, a single motor 400 may drive both sets of wheels 40, 42.

Referring to FIG. 14, the drive system includes a plurality of gears, such as a first inner gear 402 having a first diameter, a second inner gear 404 having a second diameter, a third inner gear 406 having a third diameter, a fourth inner gear 408 having a fourth diameter, and a scrubber gear 410 having a fifth diameter. In some embodiments, the first, second, third, fourth, and fifth diameters are different. In alternative embodiments, the first and third diameters are the same. In still other embodiments, the first, second, third, fourth, and fifth diameters may have varying suitable diameters.

The drive system further includes a first outer gear 412, a second outer gear 414, and a third outer gear 416, as shown in FIG. 19. The first inner gear 402 and the second outer gear 414 are arranged on opposite ends of a single shaft 420 on opposite sides of the first side wall 28. In some embodiments, diameters of the first inner gear 402 and the second outer gear 414 are the same. Similarly, the third inner gear 406 and the third outer gear 416 are arranged on opposite ends of a single shaft 422. In some embodiments, diameters of the third inner gear 406 and the third outer gear 416 are the same. Additionally, the first outer gear 412 is coupled to the motor 400.

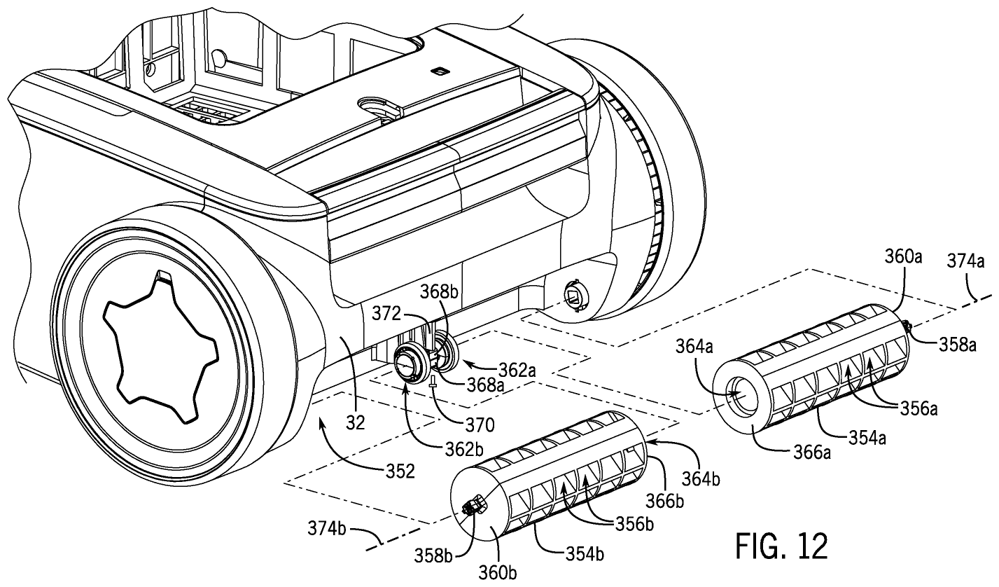

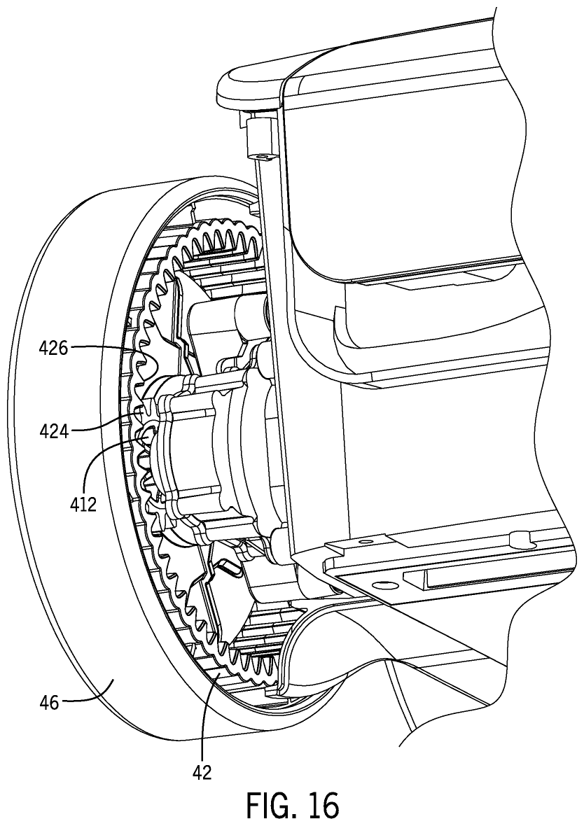

When the respective motor 400 is operated, the first outer gear 412 is rotated. As shown in FIGS. 15 and 16, the first outer gear 412 has outer gear teeth 424 that mesh with inner gear teeth 426 of the wheel 42. Rotation of the first outer gear 412 thus rotates the wheel 42. The second outer gear 414 similarly has outer gear teeth 428 that mesh with the inner gear teeth 426 of the wheel 42. Rotation of the wheel 42 thus rotates the second outer gear 414. As the second outer gear 414 rotates, so does the corresponding single shaft 420 and, thus, the first inner gear 402. As shown in FIG. 14, the first inner gear 402 has teeth 430 that engage teeth 432 of the second inner gear 404, so that rotation of the first inner gear 402 causes rotation of the second inner gear 404. Similarly, the teeth 432 of the second inner gear 404 engage teeth 434 of the third inner gear 406 to rotate the third inner gear 406. Rotation of the third inner gear 406 rotates the respective shaft 422 and, thus, rotates the third outer gear 416. Similar to the wheel 42, the wheel 40 includes inner gear teeth (not shown) that are engaged by outer gear teeth 436 of the third outer gear 416, so that rotation of the third outer gear 416 causes rotation of the wheel 40. Referring again to FIG. 14, the teeth 434 of the third inner gear 406 engage teeth 440 of the fourth inner gear 408, rotating the fourth inner gear 408. Lastly, the teeth 440 of the fourth inner gear 408 engage teeth 442 of the scrubber gear 410, rotating the scrubber gear 410. Each scrubber gear 410 can include an aperture 444 for receiving a projection, for example projection 358a of FIG. 12, of a cylindrical core, for example core 354a, of a respective scrubber 350a. In this manner, activation of the motor 400 to rotate the first outer gear 412 in a first direction D1 causes rotation of the scrubbers 350a, 350b in a second direction D2 and the wheels in a third direction D3, wherein D1, D2, and D3 can be the same direction. For example, if the motor 400 causes the first outer gear 412 to rotate in a counter-clockwise direction so that the pool cleaner 20 moves in the forward direction, the scrubbers 350a, 350b and the wheels 40, 42 similarly rotate in a counter-clockwise direction. In contrast, if the motor 400 causes the first outer gear 412 to rotate in a clockwise direction so that the pool cleaner 20 moves in a rearward direction, the scrubbers 350a, 350b and the wheels 40, 42 similarly rotate in a clockwise direction. While a certain number and orientation of gears are shown and described, some embodiments may include other numbers and/or combinations of gears in order to cause the motors 400 to drive the wheels 40, 42 and/or the scrubbers 350a, 350b.

The drive system is further configured to be modular, enabling each component to be individually serviced or replaced without significantly disassembling the pool cleaner 20. For example, each individual motor 400 is housed in a separate motor enclosure 450 formed within the housing 22. As shown in FIGS. 15 and 19, the motor enclosures 450 are formed within the side walls 28, 30 behind the rear wheels 42. A motor retainer 452 is coupled to each of the side walls 28, 30 with a fastener (not shown), and is configured to cover the opening of the motor enclosure 450. The rear wheels 42 are rotatably coupled to the motor retainer 452 with a fastener (not shown) so that the rear wheel 42 engages the drive system. In some embodiments, a hub cap 454 (as shown in FIG. 5) conceals the fastener used to couple the rear wheel 42 and the motor retainer 450. In other examples, however, a hub cap 454 can be omitted. In order to access the motor enclosure 450, a user can first remove the hub cap 454 from the rear wheel 42, exposing the fastener. The rear wheel 42 is then decoupled from the motor retainer 452, and the motor retainer 452 is subsequently decoupled from the respective side wall 28, 30.

Furthermore, in some embodiments, the first side wall 28 and second side wall 30 include a first removable panel 460 (as shown in FIG. 15) and a second removable panel (not shown), respectively. With continued reference to the right side of the pool cleaner 20, at least one of the inner gears 402, 404, 406, 408 can be coupled to an inwardly facing surface of the first removable panel 460, and at least one of the outer gears 412, 414, 416, the motor retainer 452, and the wheels 40, 42 can be coupled to an outwardly facing surface of the first removable panel 460. In order to access the interior drive system parts, a user first removes the front and rear wheels 40, 42. The removable panel 460 can then be decoupled from the housing 22 by removing one or more fasteners used to secure the removable panel 460. Once the removable panel 460 has been removed from the housing 22, the user may access any of the modular drive components for servicing or replacement. Thus, one of the motors 400 can be removed and/or serviced by removing a minimal amount of screws and without requiring a user to enter the main body of the pool cleaner 20. In some embodiments, additional drive components may need to be decoupled from the first side wall 28 to permit removal of removable panel 460.

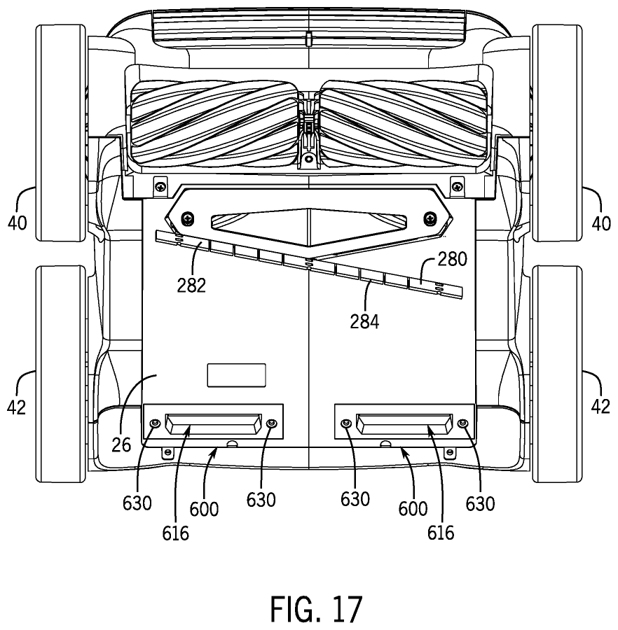

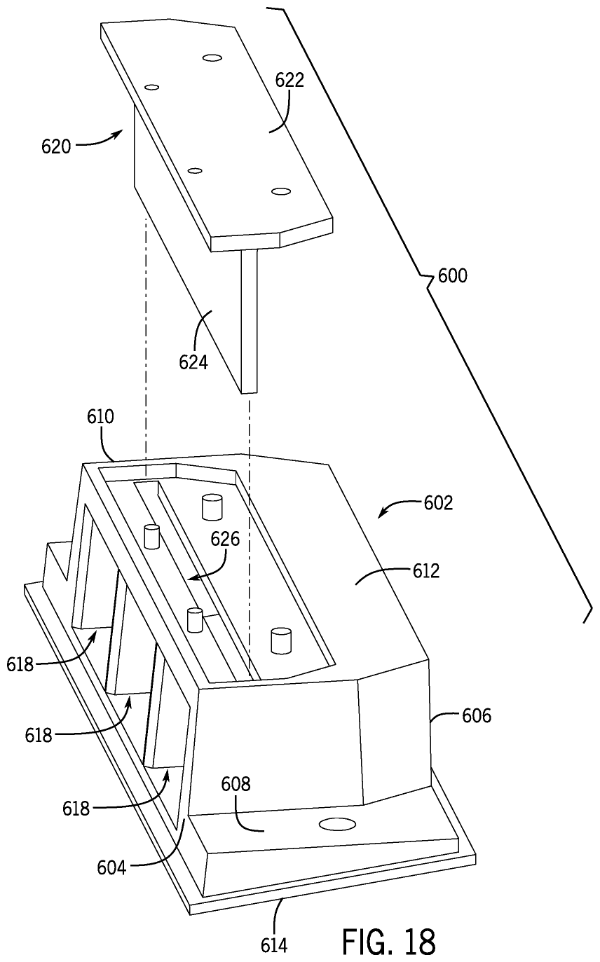

When the pool cleaner 20 is deactivated and removed from the aquatic environment, water remains within the housing 22. As shown in FIGS. 17 and 18, the pool cleaner 20 includes one or more one-way valves 600 that may allow water within the pool cleaner 20 to drain from the pool cleaner 20. Each of the one-way valves 600 is positioned or formed within the bottom wall 26 of the pool cleaner 20 and generally includes a valve housing 602 having opposing front and rear walls 604, 606, opposing side walls 608, 610, a top wall 612, and a bottom wall 614. The bottom wall 614 is coupled to the bottom wall 26 of the pool cleaner 20 and includes a cavity 616 (e.g., a vertically oriented outlet). A number of vertical channels 618 are formed in the front wall 604 and are in fluid communication with the cavity 616. A T-shaped valve flap 620 includes a first segment 622 that is coupled by a suitable attachment mechanism to the top wall 612 of the valve housing 602 and a second segment 624 that extends through a slot 626 in the top wall 612. The second segment 624 remains “closed,” that is, vertically oriented in place, covering and sealing the channels 618, when water pressure is equalized (i.e., the pool cleaner 20 is in the water), but can move away from the channels 618 when the pool cleaner 20 is removed from the water. More particularly, when the pool cleaner 20 is picked up by the handle 200 (i.e., with the longitudinal axis 270 of the pool cleaner 20 aligned vertically), the pressure of the water “opens” (e.g., moves) the second segment 624 of the valve flap 620, allowing water to drain through the channels 618 and out the cavity 616. While two one-way valves 600 are depicted near a rear of the pool cleaner 20, another suitable number of one-way valves may be utilized in other suitable locations along the bottom wall 26 or in another surface of the pool cleaner 20. Also, each of the one-way valves 600 are modular and individually removable and serviceable. For example, two fasteners 630 are used to removably couple each of the one-way valves 600 to the bottom wall 26. A user can remove the fasteners 630 in order to decouple a one-way valve 600 for repair or replacement.

As noted above, each of the front compartment 60, the upper compartment 62, and the lower compartment 66 is modular in that the components in the compartments may be separately accessed or removed (e.g., for servicing and/or replacing). For example, the front compartment 60, housing electrical components, the upper compartment 62, housing hydraulic components, and the lower compartment 66, housing drive system components can be sealed from each other so that the components within each of the compartments 60, 62, 64 can be easily accessible without substantially disrupting the other compartments. The front compartment 60 can further be sealed in manner that makes it a waterproof enclosure.

Additionally, each of the drive system, the hydraulic system, and a collector system (e.g., including collector components configured to collect debris, such as the scrubbers 350a, 350b and the skirt 280), are modular so that their respective components may be separately accessed and/or removed without disturbing the other systems. More generally, in some embodiments, any wear item of the pool cleaner 20 can be individually accessible for easy removal, servicing, and/or replacement. A non-exhaustive list of components of the pool cleaner 20 that are modular or accessible via separate modular compartments can include at least one of the motor 400, the motor retainer 452, at least one of the inner gears 402, 404, 406, 408, at least one of the outer gears 412, 414, 416, the front wheels 40, the rear wheels 42, the hub caps 454, the pump, the shaft 304, the pump impeller 308, the scrubbers 350a, 350b, the cylindrical cores 354a, 354b, the cylindrical brushes 390a, 390b, the skirt 280, the one-way valve 600, the debris container 64, the electronics housing 70, and/or other components of the pool cleaner 20. While many of the modular components have been described as being secured to the pool cleaner 20 with a fastener, such as a screw, other fasteners or fastening configurations can be used. In one example, a quick disconnect or quick release feature (not shown) may be used for retaining connections within the pool cleaner 20. The quick disconnect feature can be movable between a locked position and an unlocked position, where a modular feature is retained when the feature is in the locked position and may be removed when the feature is in the unlocked position. In some embodiments, the quick disconnect feature may be a quick-turn disconnect, or more particularly a 60-degree turn quick disconnect, that includes a rotatable portion that may be turned or rotated between the locked and unlocked positions.

In this manner, if there are any issues with any of the noted components, those individual components may be individually accessed for service or replacement. Additionally, isolating these individual components (e.g., in separate compartments) decreases the likelihood of failure or fault of one component affecting functionality of any of the other individual components. For example, if a seal about the motor shaft fails, the other components are not affected.

While a particular pool cleaner 20 and variations are described above, it should be understood that the principles of the invention may be implemented within other types of pool cleaners. For example, the principles of the invention may be implemented within a suction or pressure side pool cleaner, within a pool cleaner having different components, features, and/or functions than the pool cleaner 20 described above.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A pool cleaner comprising:
a housing; and
a debris container defining a plane parallel to a surface on which the pool cleaner is configured to be positioned, the debris container being slidably coupled to the housing and the debris container movable in a direction other than perpendicular to the plane for removal from the housing.

2. The pool cleaner of claim 1, wherein the housing includes a first and second opposing side walls, front and rear opposing walls, and a bottom wall all forming a cavity for collection of debris, and a lid removably coupled to the housing to enclose the debris container when the debris container is positioned within the housing of the pool cleaner.

3. The pool cleaner of claim 2, wherein the lid includes a transparent window positioned above at least a portion of the housing of the debris container for viewing of debris within the housing.

4. The pool cleaner of claim 1, wherein the housing defines a cavity; and further comprising a lid coupled to the housing and enclosing the cavity, the lid movable between an open and closed position, wherein the debris container is housed within the cavity, the debris container being ejected from the cavity when the lid is moved from the closed position to the open position.

5. The pool cleaner of claim 4, wherein the lid is hingedly coupled to the housing so that the lid is rotatable between the open position and the closed position.

6. The pool cleaner of claim 1, and further comprising:
a hydraulic system configured to pull water and debris into the housing and push filtered water out of the housing after the debris is collected in the debris container, the hydraulic system including:
a pump including a pump motor housed within a pump housing including three protrusions, a shaft extending from the pump motor, and a pump impeller coupled to an end of the shaft opposite the pump motor, and
an outlet system including an inlet manifold configured to receive the pump impeller and at least one outlet duct configured to direct the filtered water from the inlet manifold out of the housing, the inlet manifold including three apertures, each receiving one of the three protrusions to align the pump housing with the inlet manifold.

7. A pool cleaner comprising:
a housing including opposing front and rear walls, opposing first and second side walls, a top wall, and a bottom wall;
at least two wheels coupled to the first and second side walls for moving the pool cleaner along a surface; and
at least one scrubber positioned between the at least two wheels, the at least one scrubber including a plurality of vanes arranged in a helical pattern.

8. The pool cleaner of claim 7, wherein the at least one scrubber comprises a cylindrical core with a brush disposed around the cylindrical core.

9. The pool cleaner of claim 8, including first and second scrubbers positioned coextensive with one another between the at least two wheels, each of the first and second scrubbers including a plurality of vanes arranged in a helical pattern.

10. The pool cleaner of claim 9, wherein the helical pattern of the first scrubber spirals in a counter-clockwise direction between the first side wall toward a point between the first and second scrubbers and the helical pattern of the second scrubber spirals in a clockwise direction the point between the first and second scrubbers toward the second side wall.

11. A pool cleaner comprising:
a housing;
a debris container positioned within the housing; and
a hydraulic system configured to pull water and debris into the housing and push filtered water out of the housing after the debris is collected in the debris container, the filtered water exiting the housing through a top wall of the housing.

12. The pool cleaner of claim 11, wherein the filtered water exits an outlet system that splits into two outlet ducts that exit first and second opposing sides of the top wall of the housing.

13. The pool cleaner of claim 12, wherein a flow of water out each of the two outlet ducts has a vertical component and a horizontal component, the vertical component being greater than the horizontal component.

14. The pool cleaner of claim 11, and further comprising:
a plurality of compartments formed within the housing, including a first compartment housing hydraulic components, a second compartment housing electrical components, and a third compartment housing drive system components,
each one of the compartments being sealed from the other compartments so that components within each of the compartments are individually accessible.

15. The pool cleaner of claim 14, wherein at least the second compartment is a waterproof enclosure.

16. The pool cleaner of claim 11, and further comprising:
a drive system; and
a collector system,
the drive system including a plurality of drive components collectively operable to move the housing along a surface to be cleaned, at least one of the drive components being removable without disturbing the hydraulic system and the collector system,
the hydraulic system including a plurality of hydraulic components collectively operable to move fluid through the housing, at least one of the hydraulic components being removable without disturbing the drive system and the collector system, and
the collector system including a plurality of collector components collectively operable to collect debris from the surface to be cleaned, at least one of the collector components being removable without disturbing the hydraulic system and the drive system.

17. The pool cleaner of claim 16, wherein at least one of the drive components, the hydraulic components, or the collector components is retained by a quick disconnect feature.

18. The pool cleaner of claim 16, wherein the drive components include one or more motors and a plurality of gears; the hydraulic components include a pump motor, a shaft, and a pump impeller; and the collector components include a scrubber and a skirt.

19. The pool cleaner of claim 11, and further comprising a one-way valve formed in a bottom wall of the housing, the one-way valve including a vertically-oriented outlet and a vertically-oriented one-way valve flap covering the vertically-oriented outlet in a closed condition.

20. The pool cleaner of claim 11, wherein the housing includes first and second opposing side walls, opposing front and rear walls, a top wall, and a bottom wall; and further comprising:
a first wheel and a second wheel coupled to each of the first and second side opposing walls, respectively, for moving the pool cleaner along a surface; and
a drive system including a motor configured to drive at least one of the first or second wheels, the motor being modularly retained within the housing so that the motor is individually accessible.

21. The pool cleaner of claim 20, wherein the motor includes a first motor and a second motor configured to drive the first wheel and the second wheel, respectively, wherein each one of the first and second motors is housed in a separate motor enclosure.

22. The pool cleaner of claim 21, wherein the drive system further comprises at least one first gear configured to link the first wheel to the first motor and at least one second gear to link the second wheel to the second motor.

23. A pool cleaner comprising:
a housing including first and second opposing side walls, opposing front and rear walls, a top wall, and a bottom wall;
a debris container received within the housing; and
an inlet manifold extending between the bottom wall of the housing and the debris container, the inlet manifold having a cross-section that decreases from the bottom wall to the debris container.

24. The pool cleaner of claim 23, wherein the cross-section of the inlet manifold is hexagonal in shape.

25. The pool cleaner of claim 23, wherein a length of the inlet manifold increases from outside edges of the inlet manifold to a center of the inlet manifold.

26. The pool cleaner of claim 23, wherein the inlet manifold includes an inlet adjacent the bottom wall and a lip extending around the inlet, the lip being removably fastened to the bottom wall of the housing.
